(19) United States
(12) Patent Application Publication
(10) Pub. No.: US 2004/0035156 A1
(43) Pub. Date: Feb. 26, 2004

(54) Fleshing method and device therefor

(76) Inventor: Gerard Tessier, Gatineau (CA)

Correspondence Address: Gerard Tessier, 441, Cheval Blanc, Gatineau, QC, J8P 6P4, CA

(21) Appl. No.: 10/449,015

(22) Filed: Jun. 2, 2003

(30) Foreign Application Priority Data
Jun. 1, 2002 (GB) 0212793.4

(51) Int. Cl. C14B 15/06

(52) U.S. Cl. 69/19.1; 69/19

(57) ABSTRACT

A fleshing device for removing flesh from a hide includes a hide supporting structure for supporting the hide so that the hide extends in a substantially vertical hide plane. The device also includes a fleshing tool having a fleshing blade for removing the flesh from the hide and a tool supporting structure for movably supporting the fleshing tool so as to allow the fleshing tool to be moved in a tool plane substantially parallel to the hide plane while the fleshing blade operationally contacts the flesh.

### FIELD OF THE INVENTION

The present invention relates to the general field of hide fleshing and is particularly concerned with a fleshing method and device therefor.

### BACKGROUND OF THE INVENTION

The treatment of animal skins, furs and hides to produce useful garments or covers is an ancient art. Such ancient art usually requires the craft of fleshing as a necessary step.

One of the simplest hand tool still employed today for fleshing is a fleshing knife typically characterized by being a generally blunt and concave blade. The animals to be fleshed are first killed and skinned. The pelts are then mounted inside out in a sleeve-like manner typically on a papered pole. The fleshing knife is then used to scrape or shave the animal pelt or hide free of fat, membrane and other adherent tissue.

The manual use of fleshing knives suffers from numerous drawbacks including potential injury to the hides, particularly around the tail and legs in situations wherein the hide is relatively thin. Also, manual scraping with a fleshing knife is time consuming, tedious and unergonomical.

Advances with time brought on the development of more elaborate fleshing tools and machines, including relatively large power driven stationary machines into which large pelts or hides can be fed rapidly. Generally, the large stationary machines include a flat table supporting the hide and a cylindrical fleshing component.

During the fleshing operation, it is typically necessary the skin or hide under tension while it is passed in front of a series of blades or knives which are usually mounted on a rotating roller. In order to perform the fleshing operation, it is necessary for the skin to be processed from its center towards its ends. This is typically because the ends of the skin correspond to the head, paws and tail of the animal and it would be difficult to start the processing from these regions. Thus, approximately one half of the skin is introduced into a typical defleshing machine and is located between a pair of driving rollers.

These rollers typically advance the skin and subjected to the cutting action of a series of blades mounted on a roller rotating in opposite direction to the direction of advance of the skin. Upon the introduction of the first half of the skin between the rollers, an intended operator is obliged, in order for continuous processing to be achieved to turn over the half of the skin which is not passed between the driving rollers.

The intended operator then must locate the unprocessed half of the skin into a conveyor belt so as to cause it to advance towards the second defleshing machine. The operation is again tedious and unergonomical.

Accordingly, smaller hand held fleshing tools have been developed. These hand held fleshing tools allow much more accurate fleshing than could be obtained with a large machine. One major disadvantage associated with stationary machines is that the machine will typically flesh a flat hide to a rather precise thickness without regard for the fact that the hide will have variations in thickness of suitable hide material and unwanted adhering flesh. The treated hide may merge from the machine having an even thickness, but portions may still include flesh.

When using a portable form of fleshing tool, similarly to the use of a conventional fleshing knife, the operator usually mounts a pelt inside out upon a sturdy elongated mounting pole or cylinder. The portable fleshing tool is then applied to the fleshy surfaces by grasping a pair of longitudinally oriented handles in alignment with a cylindrical fleshing component. The operator then guides the fleshing component over the pelt. From the foregoing, it becomes quite evident that conventional fleshing tools allow limited control of the kind and quantity of the resulting surface and product.

Another main drawback associated with prior art devices relates to the necessity of manually manipulating the skin or pelt in an often unergonomical environment. If it is taken into consideration that typical skins may be 2 or 3 meters in length and relatively heavy, it would be understood that the turning over of the skin, imbued with fatty substances requires considerable use of manpower and time. Furthermore, the skin imbued with fatty substances is often both repellent and slippery, further compounding the problem of manipulation. Hence, the manipulation of wet hides of large animals is heavy and messy work.

Expert workmen in this area develop a feel for the operation of the knife or machine. The fleshing knife or other manually operated flesh removing device is to be pressed and moved against the pelt with a carefully applied force. The force must be sufficient to remove fat and other tissues while preventing cutting into or damage to the skin of the pelt. When the operator becomes tired as successive pelts are processed, the feel of the operator tends to diminish which can lead to spoiled pelts and diminish productivity. Accordingly, there exists a need for an improved fleshing method and device.

### SUMMARY OF THE INVENTION

It is an object of the present invention to provide an improved fleshing method and an associated improved fleshing device. Generally, the proposed method and device allows the fleshing implement to be moved relative to the skin as opposed to requiring moving the skin relative to the tool.

In accordance with the present invention, there is provided a fleshing device for removing flesh from a hide, the fleshing device comprising: a hide supporting means for supporting the hide so that the hide extends substantially in a hide plane, the hide plane having a substantially vertical orientation; a fleshing tool, the fleshing tool having a fleshing blade for removing the flesh from the hide; a tool supporting means for movably supporting the fleshing tool so as to allow the fleshing tool to be moved in a tool plane substantially parallel to the hide plane while the fleshing blade operationally contacts the flesh.

In accordance with the present invention, there is also provided a fleshing method for removing flesh from a hide using fleshing device, the fleshing device including a hide supporting means for supporting the hide so that the hide extends substantially in a hide plane, the hide plane having a substantially vertical orientation; the fleshing device also including a fleshing tool, the fleshing tool having a fleshing blade for removing the flesh from the hide; the fleshing device further including a tool supporting means for movably supporting the fleshing tool so as to allow the fleshing tool to be moved in a tool plane substantially parallel to the hide plane while the fleshing blade operationally contacts the flesh; the fleshing method comprising the steps of: mounting the hide on the hide supporting means so that the hide is in a substantially stretched configuration and extends substantially in the hide plane; using the fleshing tool for removing at least some of the flesh from the hide while the fleshing tool is moved substantially within the tool plane. Typically, the hide plane and the tool plane extend in a substantially vertical orientation.

Advantages of the present invention include that the proposed fleshing method and device allows an intended operator to flesh animal pelts rapidly, efficiently and with reduced risks of damaging the pelts. Also, the proposed method and device allows for fleshing of animal pelts through a set of ergonomic steps with reduced operator fatigue.

Furthermore, the proposed method and device are readily adaptable for application to pelts of different sizes and derive from various species of animals. Furthermore, the proposed method and device can be used by relatively inexperienced operators with reduced risks of damaging the pelts. Still further, the proposed method and device allows use of a relatively simple fleshing implement that can be manufactured at relatively cost and requires low maintenance so as to provide a fleshing device that will be economical, long lasting and relatively trouble free in operation.

### BRIEF DESCRIPTION OF THE DRAWINGS

Various embodiments of the present invention will now be disclosed, by way of example, in reference to the following drawings in which:

FIG. 1, in a perspective view with sections taken out, illustrates a fleshing device in accordance with an embodiment of the present invention, the fleshing device being shown fleshing a hide;

FIG. 2, in a perspective view, illustrates a supporting frame part of the fleshing device shown in FIG. 1;

FIG. 3, in a perspective view, illustrates a connecting component part of the supporting frame shown in FIG. 2;

FIG. 4, in a perspective view, illustrates a frame anchoring component part of the supporting frame shown in FIG. 2;

FIG. 5, in an elevational view, illustrates a cable-to-frame attachment component part of the supporting frame shown in FIG. 2;

FIG. 6, in an elevational view, illustrates a cable-to-hide attachment hook part of the fleshing device shown in FIG. 1;

FIG. 7, in a perspective view, illustrates cable-to-hide attachment pliers part of the fleshing device shown in FIG. 1;

FIG. 8, in a front perspective view, illustrates a fleshing tool part of the fleshing device shown in FIG. 1;

FIG. 9, in a rear perspective view, illustrates the fleshing tool shown in FIG. 8;

FIG. 10a, in a partial transversal cross-sectional view, illustrates the configuration of the cutting edge part of the fleshing tool shown in FIGS. 8 and 9;

FIG. 10b, in a partial transversal cross-sectional view with sections taken out, illustrates an alternative embodiment of the cutting edge part of the blade of the fleshing tool shown in FIGS. 8 and 9;

FIG. 10c, in a partial cross-sectional view with sections taken out, illustrates yet another alternative embodiment of the cutting edge part of the cutting blade of the fleshing tool shown in FIGS. 8 and 9;

FIG. 11, in a partial elevational view with sections taken out, illustrates a cable-type supporting component part of the fleshing device shown in FIG. 1;

FIG. 12, in a partial elevational view with sections taken out, illustrates a cursor device part of the fleshing device shown in FIG. 1;

FIG. 13, in a partial perspective view with sections taken out, illustrates a tool supporting device in accordance with an alternative embodiment of the present invention; and

FIG. 14, in a partial cross-sectional view with sections taken out, illustrates a beam-type supporting component and corresponding cursor component part of the tool supporting device shown in FIG. 13.

### DETAILED DESCRIPTION

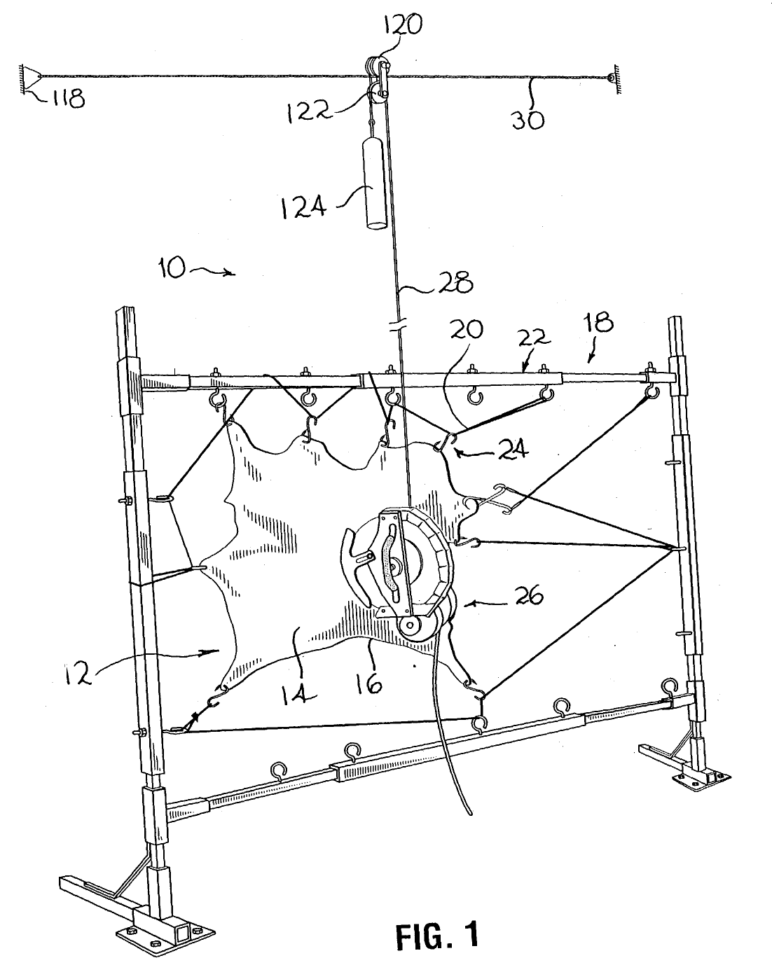

Referring to FIG. 1, there is shown, in a perspective view, a fleshing device 10 in accordance with an embodiment of the present invention. The fleshing device 10 is shown being used for fleshing a pelt or hide 12. The hide 12 typically defines a flesh side 14 and an opposed fur or hair side (not shown). Projections of flesh, fat and possibly other body material typically protrude from the flesh side 14.

The hide 14 also defines a hide peripheral edge 16. The hide peripheral edge 16 typically has a generally irregular configuration such as shown in FIG. 1. It should be understood that the fleshing device 10 is adapted to be used with pelts or hides 12 of various sizes and configurations without departing from the scope of the present invention and that the hide 12 shown in FIG. 1 merely represents an example of a typical hide from which the flesh and other body parts are removed using the fleshing device 10.

In general terms, the fleshing device 10 includes a hide supporting means 18 for supporting the hide 12 so that the hide 12 extends substantially in a hide plane having a substantially vertical orientation. The hide supporting means 18 is intended to support the hide 12 in a substantially stretched out or generally flat configuration such as shown in FIG. 1. Typically, the hide supporting means 18 supports the hide 12 in a substantially taut state for facilitating the fleshing thereof.

It should be understood that although FIG. 1 illustrates the hide supporting means 18 as supporting the hide 12 so that the latter extends in a substantially vertical orientation, the hide supporting means may also support the hide 12 in other non-horizontal orientations without departing from the scope of the present invention. The vertical orientation of the hide 12, however, typically facilitates the fleshing operation so that the latter is performed in an ergonomic manner.

In general terms, the fleshing device 10 also includes a fleshing implement or tool 20. The fleshing tool 20 has a fleshing blade 22 for removing the flesh and/or other body parts from the flesh side 14 of the hide 12.

In general terms, the fleshing device 10 further includes a tool supporting means 24 for movably supporting the fleshing tool 20 so as to allow the latter to be moved in a tool plane substantially parallel and adjacent to the hide plane while the fleshing blade 22 operationally contacts the flesh side 14 of the hide 12.

The hide supporting means 18 typically includes a hide supporting frame 26 and a frame-to-hide attachment means 28 for releasably attaching the hide 12 to the hide supporting frame 26. Preferably, the hide supporting frame 26 is adjustable in size for accommodating hides of various sizes.

Typically, the hide supporting frame 26 includes peripheral frame rods or members. Typically, the frame-to-hide attachment means 28 includes hide attachment cables 30 attachable to both the peripheral frame members and the hide 12 using respectively cable-to-frame attachment means 32 and cable-to-hide attachment means 34.

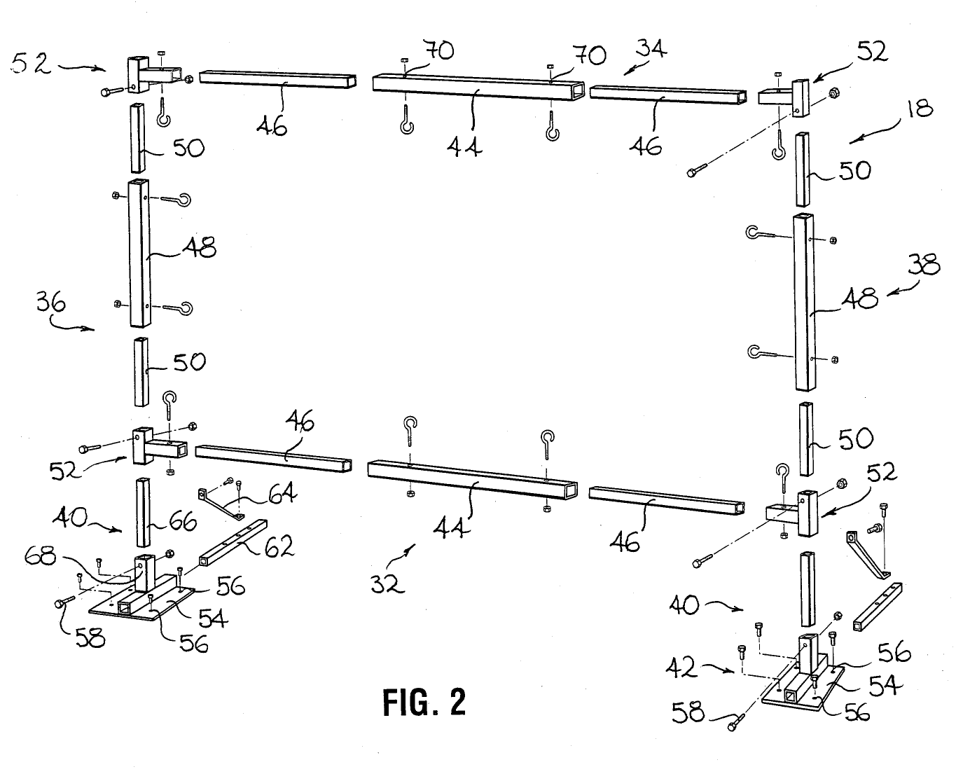

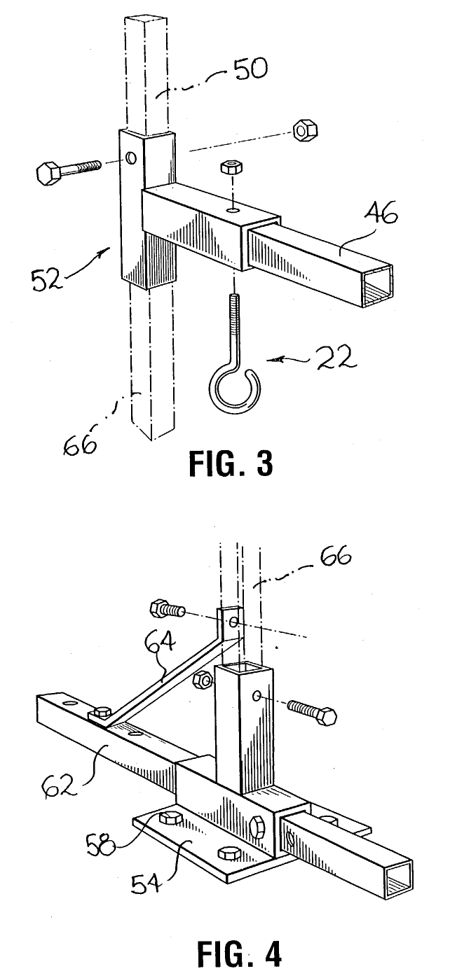

Referring now more specifically to FIGS. 2 through 4, there is shown in greater details one possible embodiment of a hide supporting means 18. The hide supporting frame 26 typically includes a set of four peripheral frame members 36 including a pair of substantially horizontally oriented frame members 36 and a pair of substantially vertically oriented frame members 36 to maintain a spaced apart relationship relative to each other so as to form a substantially rectangular peripheral frame edge.

It should be understood that although the hide supporting frame 26 is shown as having a generally rectangular configuration throughout the figures, the hide supporting frame 26 could have other configurations without departing from the scope of the present invention.

At least one and preferably all of the peripheral frame members 36 are typically adjustable in length. Typically, each peripheral frame member 36 includes a corresponding central members segment 38 and a pair of corresponding lateral member segments 40.

The central and lateral member segments 38, 40 are typically assembled together in a telescopic manner so as to allow for length adjustment of the corresponding peripheral frame members 36. It should be understood that the peripheral frame members 36 could be provided with other types of length adjustment means without departing from the scope of the present invention.

Typically, the peripheral frame members 36 are assembled together adjacent end sections thereof by generally T-shaped corner members 42. It should be understood that the peripheral frame members 36 could be otherwise assembled together without departing from the scope of the present invention.

The hide supporting frame 26 typically further includes frame leg members 44 attached to the bottom corner members 42. The hide supporting frame 26 typically still further includes a frame anchoring assembly 46 attached to each frame leg member 44 for anchoring the hide supporting frame 26 to a ground surface.

Each frame anchoring assembly 46 typically includes a corresponding anchoring plate 48 having at least one and preferably a set of anchoring apertures 50 extending therethrough. Conventional anchoring components such as bolts 52 or the like are inserted through the anchoring apertures 50 for anchoring the anchoring plate 48 to the ground surface.

Each frame anchoring assembly 46 typically also includes a leg receiving sleeve 54 attached to a corresponding anchoring plate 48 for receiving a corresponding frame leg member 44. Typically, each frame anchoring assembly 46 still further includes a stabilising member 56 slideably inserted into a corresponding stabilising sleeve 58 attached to the anchoring plate 48. The stabilising member 56 is slideably inserted within the corresponding stabilising sleeve 58 for allowing adjustment of the length of the protruding segment of the stabilising member 56 protruding from the anchoring plate 48 so as to allow for adjustment of the size of the sustentation polygon of the frame anchoring assembly 46 depending on factors such as the weight of the hide 12 being supported by the hide supporting frame 26, the available anchoring ground area and the like.

Optionally, reinforcement braces 60 extend between the leg receiving sleeves 54 and a corresponding stabilising member 56. The various components of the hide supporting frame 26 are typically assembled together using conventional fastening components such as fastening bolts 62 and corresponding fastening nuts 64.

The cable-to-frame attachment means 32 may take any suitable form. In the embodiments shown throughout the figures, the cable-to-frame attachment means 32 includes at least one and typically a plurality of cable-to-frame attachment components mounted at strategic locations on the hide supporting frame 26.

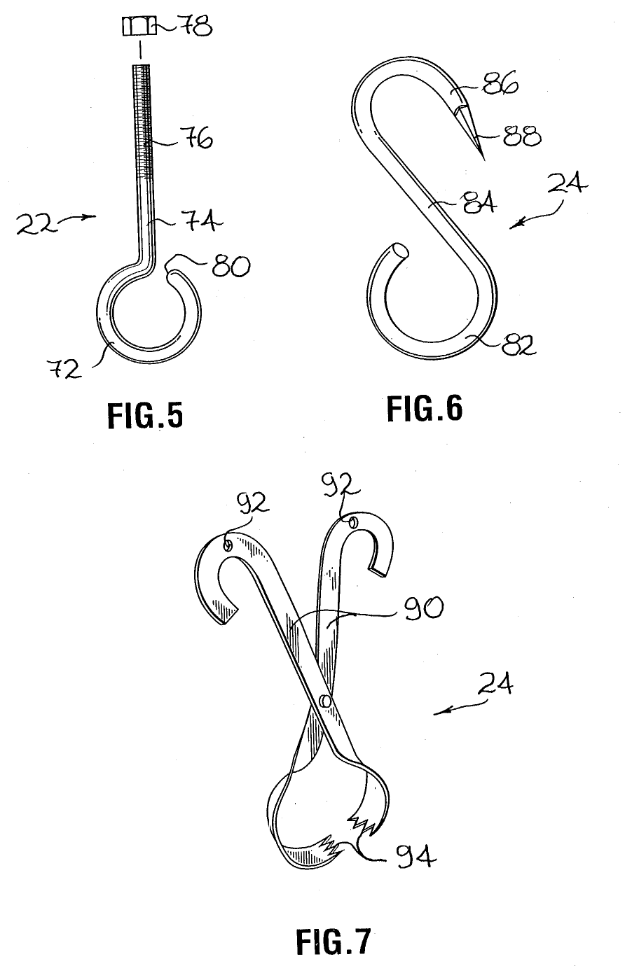

FIG. 5 illustrates in greater details the configuration of a typical cable-to-frame attachment component 32. The cable-to-frame attachment component 32 shown in FIG. 5 typically includes a generally rectilinear attachment segment 66 having a distal threaded portion 68. The attachment segment 66 is insertable in corresponding component receiving apertures 70 formed in some of the peripheral frame members 36 and/or corner members 42. The attachment segments 66 are releasably attachable to the hide supporting frame 26 using conventional fastening means such as attachment nuts 70.

Each cable-to-frame attachment component 32 typically also includes eyelet section 72 having a cable receiving slot 74 configured and sized for receiving a section of the hide attachment cable 30. It should be understood that the cable-to-frame attachment component 32 could have other configurations without departing from the scope of the present invention.

The cable-to-hide attachment means 34 may take any suitable form. In the embodiments shown throughout the figures, the cable-to-hide attachment means includes generally S-shaped hide attachment hooks 76 such as shown in FIG. 6 and/or generally X-shaped hide attachment pliers 78 such as shown in FIG. 7.

As shown more specifically in FIG. 6, the hide attachment hook 76 typically includes a generally arcuate cable attachment section 80 extending integrally into a generally rectilinear spacing segment 82. The cable attachment and spacing segments 80, 82 typically define a cable insertion slot 84 therebetween configured and sized for receiving a portion of the hide attachment cable 30.

The spacing segment 82, in turn, extends integrally into a generally arcuate hide attachment segment 86 having a substantially pointed end 88 for insertion into the hide 12 typically adjacent the hide peripheral edge 16. It should be understood that the hide attachment hook 76 may have other configurations without departing from the scope of the present invention.

As shown more specifically in FIG. 7, the hide attachment pliers 78 typically include a pair of plier arms 90 pivotally attached together about an arm pivotal link 92. Each plier arm 90 is provided with a cable receiving aperture 94 adjacent a longitudinal end thereof for receiving a section of the hide attachment cable 30.

Each plier arm 90 is typically also provided with a gripping section 96 located substantially opposite the cable receiving aperture 94 and having a substantially jagged gripping edge 98 for gripping into the hide 12 typically adjacent the hide peripheral edge 16 such as shown in FIG. 1. It should be understood that the hide attachment pliers 78 could have other configurations without departing from the scope of the present invention.

As illustrated more specifically in FIGS. 1 and 11 through 13, the tool supporting means 24 typically includes a generally elongated supporting component such as a cable 100 or beam 102. The tool supporting means also typically includes a cursor device 104, 104′ mechanically coupled to the supporting component for allowing guided movement of the cursor device 104, 104′ along the supporting component.

The tool supporting means 24 typically further includes a linking device such as linking cable 106 or a linking assembly 108 attachable to the cursor device 104, 104′ and to the fleshing tool 20 for suspending the fleshing tool 20 to the supporting component so that the fleshing tool 20 is substantially in register with the hide 12 by allowing the fleshing tool 20 to move along the supporting component solidarity with the corresponding cursor device 104, 104′.

The supporting component 100, 102 is typically positioned substantially above the hide supporting means 18 so as to extend substantially thereacross. Also, the supporting component 100, 102 is typically positioned so as to be substantially in register with the tool plane.

In the embodiment shown in FIGS. 1, 11, and 12, the supporting component includes the supporting cable 100 and cable attachment means 110 allowing attachment of the supporting cable 100 to suitable supporting surfaces such as a ceiling or vertical attachment walls 112.

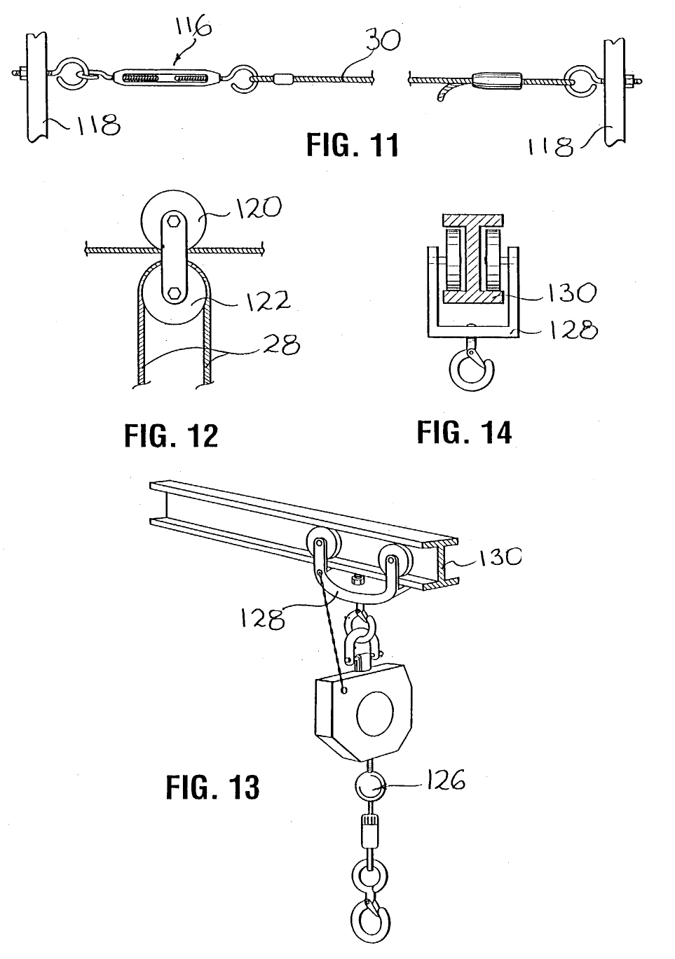

As illustrated more specifically in FIG. 11, a cable tensioning component 114 may be provided for maintaining the cable 100 in a substantially taut state so as to allow for adjustment of the length of the supporting cable 100 depending on the spacing between the supporting walls 12.

In the embodiment shown in FIGS. 1, 11, and 12, the cursor device 104 includes first cable pulley 116 rollably mounted on the supporting cable 100 for rolling movement therealong. The cursor device 104 also includes a second cable pulley 118 mechanically coupled to the first cable pulley 116 by at least and preferably a pair of first-to-second pulley coupling plates 120.

The linking cable 106 is typically at least partially wound around the second cable pulley 118. The first cable pulley 116 typically allows supported movement of the fleshing tool 20 in a generally horizontal direction while the second cable pulley 118 allows supported movement of the fleshing tool 20 in a generally vertical direction.

The tool supporting means 24 typically includes a manipulation facilitating means operatively coupled to the fleshing tool 20 for facilitating the manipulation of the fleshing tool 20 as the fleshing tool 20 is moved in the tool plane. In the embodiment shown in FIGS. 1, 11, and 12, the manipulation facilitating means includes a counter-weight system mechanically coupled to the fleshing tool 20 for reducing the force required by an intended user to support the fleshing tool 20 against the force of gravity. The counter-weight system typically includes having the linking cable 106 attached to a counter-weight component 122 adjacent one of the longitudinal ends and to the fleshing component 20 adjacent its opposed longitudinal end.

In the embodiment shown in FIGS. 13 and 14, the cursor device 104′ includes at least one and typically four guiding wheels 124 (only two of which are shown both in FIGS. 13 and 14) rollably mounted on the supporting beam 102.

Typically, although by no means exclusively, the supporting beam 102 has a generally H-shaped configuration. The guiding wheels 124 are rotatably mounted on the supporting beam 102 for rolling movement therealong. The cursor device 104′ also includes a carriage component 126 mechanically coupled to the guiding wheels 124 for movement solidarily therewith.

The assembly 108 is attached both to the carriage component 126 and to the fleshing tool 20. In the embodiment shown in FIG. 13, the assembly 108 includes a linking cable 106 extending from a cable coiling component 128 attached to the carriage component 126. The manipulation facilitating means includes having the cable coiling component 128 provided with biasing means for biasing the linking cable 106 towards its coiled state. Hence, in the embodiment shown in FIGS. 13 and 14, the guiding wheels 124 allow supported movement of the fleshing tool 20 in a generally horizontal direction while the cable component 128 allows supported movement of the fleshing tool 20 in a generally vertical direction.

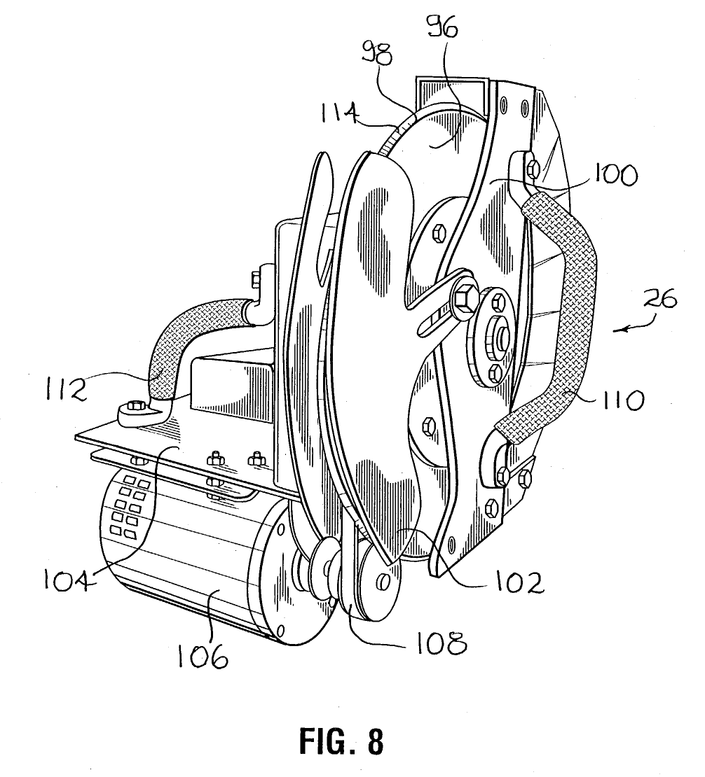

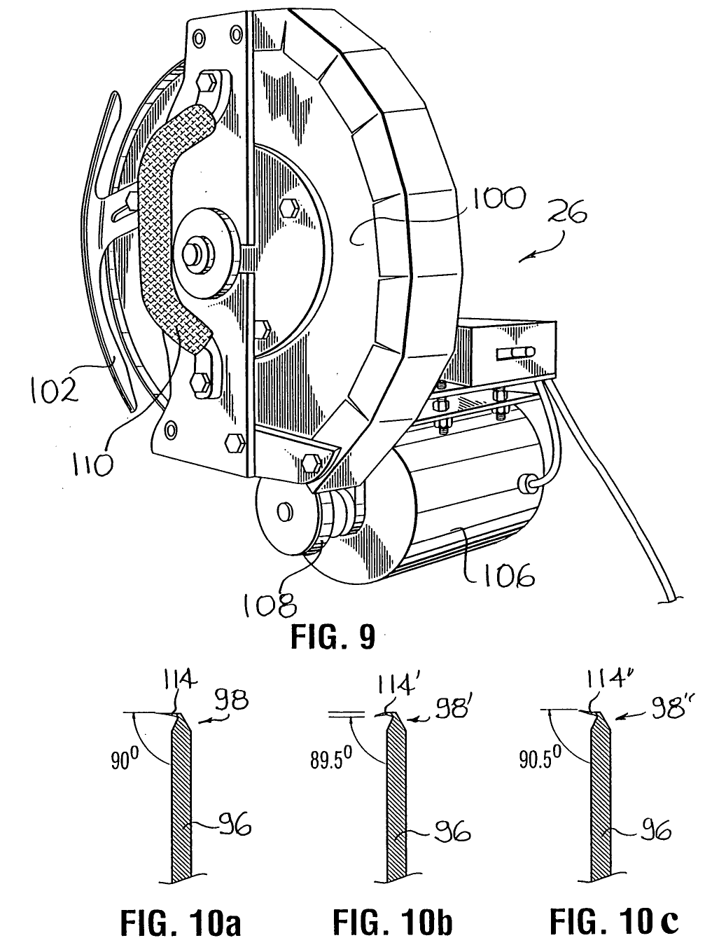

Referring now more specifically to FIGS. 8 and 9, there is shown a possible embodiment of the fleshing tool 20. The fleshing tool 20 typically includes a rotary disc blade 130 defining a substantially circular blade cutting edge 132. The fleshing tool 20 typically also includes a blade driving means operatively coupled to the rotary disc blade 130 for rotatably driving the latter.

In the embodiment shown in FIGS. 8 and 9, the blade driving means includes a rotary motor 134 mechanically coupled to the rotary disc blade 130 using a driving belt 136. It should, however, be understood that the blade driving means could take any suitable form without departing from the scope of the present invention. Typically, the driving motor 134 is attached to a housing 138 including a motor mounting plate 140.

An actuating component 142 including an actuating trigger 144 operatively coupled to the driving motor 134 is provided for allowing selective actuation of the latter. Typically, the rotary motor 134 is an electric type of motor and the actuating component 142 is an electrical switch. It should, however, be understood that other types of motors and corresponding other types of actuating devices could be used without departing from the scope of the present invention.

In the embodiment shown in FIGS. 8 and 9, the fleshing tool 20 also includes a blade depth customisation means for allowing customisation of the usable blade depth over a predetermined blade arc segment. Typically, the blade depth customisation means includes at least one and preferably a pair of blade guarding plates 146 extending on each side of the rotary disc blade 130 over the predetermined blade arc segment.

Each of the blade guarding plates 146 defines a corresponding guarding plate abutment edge 148 for abutting against the flesh side 14 of the hide 12 so as to abuttingly limit the depth of the predetermined blade arc insertable into the flesh of the hide 12. Typically, the distance between the guarding plate abutment edges 148 and the blade cutting edge 132 is adjustable so as to allow for customisation of the usable blade depth over the predetermined blade arc segment.

Typically, the fleshing tool 20 further includes a fixed blade guard 150 extending over a protected arc segment of the rotary cutting blade 130. Typically, the blade guarding plates 146 are adjustably attached to the fixed guard 150 for allowing adjustment of the relative positional relationship therebetween and, hence, for allowing customisation of the usable blade depth over the predetermined blade arc segment.

Typically, the blade guarding plates 146 are provided with attachment tongues 152 extending integrally therefrom. The attachment tongues 152 are, in turn, provided with attachment slots 154 extending therethrough. An attachment component 156, such as a bolt or the like, extends through the attachment slot 154 and is anchored into the corresponding segment of the fixed guard 150 for adjustably attaching the blade guarding plates 146 to the fixed guard component 150.

Typically, the fleshing tool 20 further includes at least one and preferably two handles 158, 160 extending therefrom for facilitating the manipulation of the fleshing tool 20. In the embodiment shown in FIGS. 8 and 9, the first and second tool handles 158, 160 extend in a substantially perpendicular relationship relative to each other.

The fleshing tool 20 further includes a tool attachment means for attaching the tool supporting means 24 thereto. The tool attachment means may take any suitable form such as a tool attachment eyelet (not shown) for attaching the distal end of the tool attachment cable 106 thereto.

As shown more specifically in FIGS. 10a through 10c, the rotary disc blade 130 may be provided with a cutting flange 162 extending integrally therefrom adjacent the circular blade cutting edge 132. In the embodiment shown in FIG. 10a, the cutting flange 162 extends generally rectilinearly and perpendicularly from the rotary disc blade 130.

In the embodiment shown in FIG. 10b, cutting flange 162′ has a distal tip 164 extending inwardly so as to form a generally convex cutting flange 162′. Typically, although by no means exclusively, a distal segment 164 extends at an angle having a value of approximately 89.5 degrees relative to the rotary disc blade 130.

In another alternative embodiment of the invention shown in FIG. 10c, the cutting flange 162″ has a distal segment 164 extending generally outwardly so as to form a cutting flange having a generally concave configuration. Typically, the distal segment 164 extends at an angle having a value of approximately 90.5 degrees relative to the rotary disc blade 130. It should be understood that the rotary disc blade 130 and associated cutting flanges 162 through 162″ could have other configurations without departing from the scope of the present invention.

The present invention also relates to a fleshing method for removing flesh from a hide such as hide 12. The method includes the step of supporting the hide 12 in a substantially flat configuration so that the hide 12 lies in a substantially non-horizontal and preferably vertical hide plane. A mechanical fleshing implement such as the fleshing tool 20 or the like is then used for fleshing the hide 12 by moving the fleshing implement relative to the hide 12 while the hide 12 remains substantially fixedly supported.

The hide 12 is typically stretched out in a generally taut state. The fleshing implement is typically suspended and allowed to move both horizontally and vertically relative to the hide 12.

One of the main advantages of the present invention resides in that only the fleshing tool 20 needs to be moved relative to the hide 12 positioned in a readily accessible position. Also, preferably, since the fleshing implement 20 is typically coupled to a manipulation facilitating means, the intended user only needs to ergonomically manipulate the fleshing tool 20 instead of having to move the hide 12 relative to the fleshing tool. Also, the vertical positioning of the hide 12 facilitates ergonomic access to its flesh side 14.

The embodiments of the invention in which an exclusive privilege or property is claimed are defined as follows:

1. A fleshing device for removing flesh from a hide, said fleshing device comprising:
a hide supporting means for supporting said hide so that said hide extends substantially in a hide plane, said hide plane having a substantially vertical orientation;
a fleshing tool, said fleshing tool having a fleshing blade for removing said flesh from said hide;
a tool supporting means for movably supporting said fleshing tool so as to allow said fleshing tool to be moved in a tool plane substantially parallel to said hide plane while said fleshing blade operationally contacts said flesh.

2. A fleshing device as recited in claim 1 wherein said fleshing tool includes
a rotary disc blade defining a substantially circular blade cutting edge;
a blade driving means operatively coupled to said rotary disc blade for rotatably driving said rotary disc blade.

3. A fleshing device as recited in claim 2 wherein said fleshing tool further includes a tool attachment means for attaching said tool supporting means thereto.

4. A fleshing device as recited in claim 3 wherein said fleshing tool further includes at least one tool handle extending therefrom for facilitating the manipulation of said fleshing tool.

5. A fleshing device as recited in claim 3 wherein said fleshing tool further includes at least two tool handles extending therefrom for facilitating the manipulation of said fleshing tool, said tool handles extending in a substantially perpendicular relationship relative to each other.

6. A fleshing device as recited in claim 2 wherein said fleshing tool also includes a blade depth customizing means for allowing customization of the usable blade depth over a predetermined blade arc segment.

7. A fleshing device as recited in claim 6 wherein said blade depth customizing means includes a pair of blade guarding plates extending on each side of said rotary disc blade over said predetermined blade arc segment, each of said blade guarding plates defining a corresponding guarding plate abutment edge for abutting against said flesh so as to abuttingly limit the depth of said predetermined blade arc segment insertable into said flesh, the distance between said guarding plate abutment edges and said blade cutting edge being adjustable so as to allow for customization of the usable blade depth over said predetermined blade arc segment.

8. A fleshing device as recited in claim 1 wherein said a tool supporting means includes a manipulation facilitating means operatively coupled to said fleshing tool for facilitating the manipulation of said fleshing tool as said fleshing tool is moved in said tool plane.

9. A fleshing device as recited in claim 8 wherein said manipulation facilitating means includes a counterweight system mechanically coupled to said fleshing tool for counter-balancing the weight of said fleshing tool.

10. A fleshing device as recited in claim 1 wherein said tool supporting means includes
a generally elongated supporting component, said supporting component being positioned substantially above said hide supporting means so as to extend substantially thereacross and being substantially in register with said tool plane;
a cursor device mechanically coupled to said supporting component for allowing guided movement of said cursor device along said supporting component;
a linking device, said linking device being attached both to said cursor device and to said fleshing tool for suspending said fleshing tool to said supporting component so that said fleshing tool is in register with said hide while allowing said fleshing tool to move along said supporting component solidarly with said cursor device.

11. A fleshing device as recited in claim 10 further comprising a counterweight component attached to said linking device substantially opposite to said fleshing tool for counter-balancing the weight of said fleshing tool.

12. A fleshing device as recited in claim 10 wherein said supporting component includes a supporting cable and wherein said cursor device includes a first cable pulley rollably mounted on said supporting cable for rolling movement therealong, said cursor device also including a second cable pulley coupled to said first cable pulley by a first-to-second pulley coupling plate; said linking device including a linking cable at least partially wound around said second cable pulley, said linking cable being attached both to said fleshing tool and to a counterweight component respectively on opposite sides of said second cable pulley; whereby said first cable pulley allows supported movement of said fleshing tool in a generally horizontal direction while said second cable pulley allows supported movement of said fleshing tool in a generally vertical direction.

13. A fleshing device as recited in claim 10 wherein said supporting component includes a supporting beam and wherein said cursor device includes at least one guiding wheel rollably mounted on said supporting beam for rolling movement therealong, said cursor device also including a carriage component mechanically coupled to said at least one guiding wheel for movement solidarly therewith; said linking device including a linking cable attached both to said fleshing tool and to a cable coiling component; whereby said at least one guiding wheel allows supported movement of said fleshing tool in a generally horizontal direction while said cable coiling component allows supported movement of said fleshing tool in a generally vertical direction.

14. A fleshing device as recited in claim 1 wherein said hide supporting means includes a hide supporting frame and frame-to-hide attachment means for releasably attaching said hide to said frame.

15. A fleshing device as recited in claim 14 wherein said hide supporting frame is adjustable in size for accommodating hides of various sizes.

16. A fleshing device as recited in claim 14 wherein said hide supporting frame includes peripheral frame members, said frame-to-hide attachment means including hide attachment cables said hide attachment cables being attachable to both said peripheral frame members and said hide using respectively cable-to-frame attachment means and cable-to-hide attachment means.

17. A fleshing device as recited in claim 16 wherein said cable-to-frame attachment means includes frame hooks extending from said frame members.

18. A fleshing method for removing flesh from a hide using fleshing device, said fleshing device including a hide supporting means for supporting said hide so that said hide extends substantially in a hide plane, said hide plane having a substantially vertical orientation; said fleshing device also including a fleshing tool, said fleshing tool having a fleshing blade for removing said flesh from said hide; said fleshing device further including a tool supporting means for movably supporting said fleshing tool so as to allow said fleshing tool to be moved in a tool plane substantially parallel to said hide plane while said fleshing blade operationally contacts said flesh; said fleshing method comprising the steps of:
mounting said hide on said hide supporting means so that said hide is in a substantially stretched configuration and extends substantially in said hide plane;
using said fleshing tool for removing at least some of said flesh from said hide while said fleshing tool is moved substantially within said tool plane.

19. A fleshing method as recited in claim 18 wherein both said hide plane and said tool plane extend in a substantially vertical orientation.
